(19) United States
(12) Patent Application Publication
(10) Pub. No.: US 2022/0403213 A1
(43) Pub. Date: Dec. 22, 2022

(54) LONG TERM REMOVABLE FILMS

(71) Applicant: Avery Dennison Corporation, Glendale, CA (US)

(72) Inventors: Kyle R. HEIMBACH, Millmont, PA (US); Michael ZAJACZKOWSKI, Bellefonte, PA (US)

(21) Appl. No.: 17/631,220

(22) PCT Filed: Jul. 30, 2020
(86) PCT No.: PCT/US2020/044314

§ 371 Date: Jan. 28, 2022

Related U.S. Application Data
(60) Provisional application No. 62/880,123, filed on Jul. 30, 2019.

(51) Int. Cl. C09J 7/38

(52) U.S. Cl. CPC C09J 7/385; C09J 2203/37; C09J 2301/414; C09J 2203/306; C09J 2433/00

(57) ABSTRACT

Film constructions are disclosed that remove well from both new and aged substrates, initially and over the long term, without compromising the other possible required properties of film construction, including but not limited to, digital printability, cold temperature adhesion, durability, and conformability. Methods of protecting a surface are also disclosed.

### CROSS REFERENCE TO RELATED APPLICATIONS

The present application claims the benefit of U.S. Provisional Patent Application No. 62/880,123 filed Jul. 30, 2019, which is incorporated herein by reference in its entirety.

### FIELD

The present invention generally relates to film constructions. More particularly, the invention relates to film constructions with long term removability and other desirable properties for film constructions used in graphics applications.

### BACKGROUND

Graphic articles are used for a number of different purposes including to provide information, for advertising, and for decoration. The graphic articles may include a film or multiple layers of film and an adhesive layer to adhere the graphic article to a substrate. Graphic articles are typically flexible, which enable their attachment to a wide range of surfaces and objects. Some or all of the layers of film may contain images, such as printed images, to generate the graphic pattern or design.

Polyvinyl chloride (PVC) films have been widely used in outdoor graphics applications, such as promotional and advertising campaigns, although other polymeric films are also useful. Such applications include signs, banners, fleet graphics, architectural and wall coverings, consumer product labeling, and other pressure sensitive products.

Outdoor graphic films, such as those used in fleet graphics and outdoor signage, experience harsh environmental and climate conditions, including temperature extremes, and precipitation and sun damage, over long periods of time. Film constructions used in fleet graphics have the added requirement of easy removal after their useful lifetime, which can be more than five years, and sometimes more than ten years. At the end of their life, the film constructions ideally remove cleanly, especially as single or a few large pieces rather than in small fragmented parts, if at all. The ability of a film construction used in fleet graphics to be removable over the long term is often exacerbated by the conditions of the substrate to which the film construction was initially installed. For example, a truck panel condition, typically constructed of painted aluminum, may be new or used. In the case of a used truck panel, the paint on the aluminum panel can become brittle and chalky and can even separate from the panel due to the conditions that degrade the paint layer. No current offerings seem to address the need for a film construction that removes well from both new and aged truck panels, at both initial installation and after long-term aging. The film constructions and methods of the present invention are directed toward these, as well as other, important ends.

### SUMMARY

Film constructions that can be removed easily from both new and aged substrates, initially and over the long term, without compromising other properties of the film construction including, but not limited to, digital printability, cold temperature adhesion, durability, and conformability are described herein.

In some embodiments, the film constructions contain a backing film have a first side and a second side and a pressure sensitive adhesive provided on at least a portion of the first side of said backing film, wherein the pressure sensitive adhesive contains at least one polymer and an optional crosslinker.

In some embodiments, the at least one polymer contains the following monomer residues: (1) about 40% by weight to about 90% by weight, based on the total weight of the polymer, of at least one monomer A having a glass transition temperature of no more than about 0° C., when polymerized as a homopolymer; (2) about 0% by weight to about 10% by weight, based on the total weight of the polymer, of at least one monomer B having a glass transition temperature of greater than about 0° C., when polymerized as a homopolymer, and a Fedors Solubility Parameter of no more than about 10.5, when calculated for a homopolymer of monomer B; (3) about 0.5% by weight to about 45% by weight, based on the total weight of the polymer, of at least one monomer C having a glass transition temperature of greater than about 0° C., and a Fedors Solubility Parameter of greater than about 10.5, when calculated for a homopolymer of monomer C; and (4) about 0% by weight to about 30% by weight, based on the total weight of the polymer, of at least one monomer D having a glass transition temperature of greater than about 0° C., and a Fedors Solubility Parameter of greater than about 10.5, when calculated for a homopolymer of monomer D.

In some embodiments, the polymer has a Fedors Solubility Parameter of less than about 10.3.

In some embodiments, the polymer is described as above and monomer C is selected from C₁-C₂₀alkyl (meth)acrylate, vinyl monomer, and combinations thereof, wherein said monomer C optionally comprises at least one functional group capable of crosslinking.

In some embodiments, the polymer is as described above and monomer D is a nitrogen-containing monomer.

In some embodiments, the film constructions are as described above and the polymer has a glass transition temperature of about −20° C. to about −50° C.; and the polymer has a Fedors Solubility Parameter of less than about 10.3.

In some embodiments, the film constructions are as described above, wherein the film construction removes cleanly from an aged surface that is rough, chalky, or a combination thereof after at least 5 years of installation on the surface, based on accelerated long term removability (LTR) protocol.

In some embodiments, the film constructions are as described above, the film construction is removed as described above, and wherein the film construction passes a 2-minute Cold Peel Test with at least 0.75 lbs. of peel.

Methods of protecting a surface are also described herein. In some embodiments, the method includes applying the film constructions described above to the surface.

The above summary is provided as a general introduction to some of the embodiments of the invention, and is not intended to be limiting. Additional example embodiments, including variations and alternative configurations, of the invention are provided herein.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates an exemplary embodiment of a film construction as described herein, including the backing film, pressure sensitive adhesive, and optional release liner described herein.

FIG. 2 illustrates an exemplary embodiment of a film construction as described herein, including the backing film, pressure sensitive adhesive, optional release liner, optional coating, and optional print layer described herein.

### DETAILED DESCRIPTION

### I. Definitions

As employed above and throughout the disclosure, the following terms, unless otherwise indicated, shall be understood to have the following meanings.

As used herein, the terms “comprises,” “comprising,” “includes,” “including,” “has,” “having” or any other variation thereof, are intended are open-ended and cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” is employed to describe elements and components described herein. This is done merely for convenience and to give a general sense of the scope of the invention. This description should be read to include “one” or “at least one” and the singular also includes the plural, unless it is obvious that it is meant otherwise by the context. As used herein, the term “about,” when referring to a measurable value such as an amount, a temporal duration, and the like, is meant to encompass variations of ±10%, preferably, ±8%, more preferably, ±5%, even more preferably, ±1%, and yet even more preferably, ±0.1% from the specified value, as such variations are appropriate to perform the disclosed methods.

As used herein, “pressure sensitive adhesive” or “PSA” refers to a material that may be identified by the Dahlquist criterion, which defines a pressure sensitive adhesive as an adhesive having a one second creep compliance of greater than 1×10⁻⁶ cm²/dyne as described in Handbook of PSA Technology, Donatas Satas (Ed.), 2^{nd} Edition, page 172, Van Nostrand Reinhold, New York, N.Y., 1989. Since modulus is, to a first approximation, the inverse of creep compliance, pressure sensitive adhesives may also be defined as adhesives having a Young's modulus of less than 1×10⁶ dynes/cm². Another well-known means of identifying a pressure sensitive adhesive is an adhesive that it is aggressively and permanently tacky at room temperature and firmly adheres to a variety of dissimilar surfaces upon mere contact without the need of more than finger or hand pressure, and which may be removed from smooth surfaces without leaving a residue, as described in Glossary of Terms Used in the Pressure Sensitive Tape Industry provided by the Pressure Sensitive Tape Council, 1996. Another suitable definition of a suitable pressure sensitive adhesive is that it preferably has a room temperature storage modulus within the area defined by the following points as plotted on a graph of modulus versus frequency at 25° C.: a range of moduli from about 2×10⁵ to 4×10⁵ dynes/cm² at a frequency of about 0.1 radians/sec (0.017 Hz), and a range of moduli from about 2×10⁶ to 8×10⁶ dynes/cm² at a frequency of approximately 100 radians/sec (17 Hz). See, for example, Handbook of PSA Technology (Donatas Satas, Ed.), 2^{nd} Edition, page 173, Van Nostrand Rheinhold, N.Y., 1989. Any of these methods of identifying a pressure sensitive adhesive may be used to identify suitable pressure sensitive adhesives for use in the film constructions of the invention.

As used herein, a “glass transition temperature” or “T_{g}” of a copolymer refers to the glass transition temperature as calculated with the Fox equation [Bulletin of the American Physical Society 1, 3 Page 123 (1956)] as follows (wherein the copolymer contains two monomers):

1/T_{g}=w₁/T_{g1}+w₂/T_{g2}

For a copolymer, w₁ and w₂ refer to the weight fraction of the two comonomers, based on weight of monomers charged to the reaction vessel, and T_{g1} and T_{g2} refer to the glass transition temperatures of the two corresponding homopolymers in degrees Kelvin. For polymers containing three or more monomers, additional terms are added (wₙ/T_{g}(n)). The glass transition temperatures of homopolymers for the purposes of this invention are those reported in “Polymer Handbook”, edited by J. Brandrup and E. H. Immergut, Interscience Publishers, 1966, unless that publication does not report the T_{g} of a particular homopolymer, in which case the T_{g} of the homopolymer is measured by differential scanning calorimetry (DSC) at a heating rate of at a heating rate of 10° K/minute.

As used herein, “Fedors Solubility Parameter” refers to the value 6 calculated from the formula below devised by Fedors:

$$δ = {( \frac{\begin{matrix}\sum & Δ {e}_{i} \\ i & \end{matrix}}{\begin{matrix}\sum & Δ {v}_{i} \\ i & \end{matrix}} )}^{1 / 2}$$

where e=energy of vaporization based on the additive atomic and group contribution;
v=molar volume based on the additive atom and group contribution; and
i=each atomic and group contribution.

The FSP for a copolymer is the sum total of the products of the mole % for each individual monomer residue in the copolymer and the FSP for the individual monomers, calculated based on their homopolymer, as described in Fedors, A Method for Estimating Both the Solubility Parameters and Molar Volumes of Liquids, Polymer Engineering and Science, February, 1974, Vol. 14, No. 2.

As used herein, the expression “removes cleanly” refers to a film that may be removed from the surface to which it has been applied as a single piece or in larger pieces that do not fragment or crumble and which do not leave residual adhesive on the surface.

As used herein, a “smooth surface” refers to a surface, such as a vehicle panel, that is generally free of surface roughness, such as chalkiness, especially from the degradation of coatings on the surface. As used herein, a “rough surface” refers to a surface, such as a vehicle panel, that has surface roughness, such as chalkiness, especially from the degradation of coatings or rust or oxidation (or other chemical reaction) on the surface.

As used herein, an “aged surface” refers to a surface that is at least one month old, preferably, at least one year old, more preferably, at least five years old, and even more preferably, at least ten years old. An aged surface can be smooth. An aged surface can rough, chalky or rough and chalky, especially from the degradation of coatings, rust or oxidation (or other chemical reaction), dust, or dirt on the surface.

As used herein, an “chalky” refers to a surface that has a powdery, friable layer, which may be caused by degradation such as by exposure to UV light or other forms of radiation or other chronic or environmental conditions. Chalking may be especially prevalent on surfaces with coatings with high levels of titanium dioxide and extenders.

As used herein, the expression “long term removability” refers to a film construction removes cleanly from an aged, rough, or chalky surface or a combination thereof after at least 5 years, preferably 10 years, of installation on the surface, based on the long-term removability (LTR) test using chalky panels.

As used herein, the prefix “(meth)acryl-” refers to both “methacryl-” and “acryl-”, such as in “(meth)acrylic” (meaning both methacrylic and acrylic), “(meth)acrylate” (meaning both methacrylate and acrylate), and “(meth)acrylonitrile” (meaning both methacrylonitrile and acrylonitrile). The term “(meth)acrylate” refers to monomeric acrylic or methacrylic esters of alcohols. Acrylate and methacrylate monomers are referred to collectively herein as “(meth)acrylate” monomers. Polymers prepared from (meth)acrylate monomers are referred to as (meth)acrylate polymers.

As used herein, the term “acrylate resin” refers to at least one (meth)acrylate polymer or copolymer and may include a blend of different (meth)acrylate polymers and copolymers.

As used herein, the term “polymer” will be understood to include polymers, copolymers (e.g., polymers formed using two or more different monomers), oligomers, and combinations thereof.

The term “copolymer” is used herein to refer to polymers containing copolymerized units of at least two different monomers (i.e., a dipolymer).

As used herein, the term “ethylenically unsaturated” when used to described monomers or groups refers to monomers or groups that contain terminal ethylene groups (H₂C═CH—).

As used herein, “nitrogen-containing monomer” means an ethylenically-unsaturated monomer having at least one nitrogen atom, such those ethylenically-unsaturated monomer containing at least one amino, amide, imide, cyano functional group, and combinations thereof. Examples of nitrogen-containing monomers include, but are not limited to, (meth)acrylamide, N,N-dimethyl (meth)acrylamide, N,N-diethyl (meth)acrylamide, N,N-dipropyl acrylamide, N,N-dimethyl amino ethyl (meth)acrylamide, N,N-dimethyl amino propyl (meth)acrylamide, N,N-diethyl amino ethyl (meth)acrylamide, N,N-diethyl amino propyl (meth)acrylamide, 2-cyanoethyl (meth)acrylate, t-butylaminoethyl (meth)acrylate, (meth)acrylonitrile, n-(C₁-C₈)alkyl acrylamide and the like. The acrylamides include acrylamide and its derivatives, including the N-substituted alkyl and aryl derivatives thereof. These include N-methyl acrylamide, N,N-dimethyl acrylamide, N-ethyl acrylamide, N,N-diethyl acrylamide, N-octyl acrylamide and the like. The methacrylamides include methacrylamide and its derivatives, including the N-substituted alkyl and aryl derivatives thereof, such as N-methyl methacrylamide, N,N-dimethyl methacrylamide, N,N-diethyl methacrylamide, and the like. The vinyl amides include vinyl amides having 1 to about 8 carbon atoms including vinyl pyrrolidone, and the like.

As used herein, “gsm” means grams per square meter.

All percentages noted herein are percentages by weight based upon the weight of the composition, unless indicated otherwise.

### II. Film Constructions

Film constructions that can be removed well from both new and aged substrates, initially and over the long term, without compromising the other possible required properties of film construction, including but not limited to, digital printability, cold temperature adhesion, durability, and conformability are described herein.

In some embodiments, the film constructions contain a backing film have a first side and a second side and a pressure sensitive adhesive provided on at least a portion of said first side of said backing film, wherein said pressure sensitive adhesive comprises at least one polymer and an optional crosslinker.

In some embodiments, the polymer contains one or more of monomers A, B, C, and D as described below. In some embodiments, the polymer contains monomers A and C, as described below, and further contains B as described below. In some embodiments, the polymer contains monomers A and C, as described below, and further contains D as described below. In some embodiments, the polymer contains monomers A and C, as described below, and further contains B and D, as described below.

In some embodiments, the polymer is as described above and has a glass transition temperature of about −20° C. to about −50° C.

In some embodiments, the polymer is as described as above (e.g., composition and glass transition temperature) and the polymer has a Fedors Solubility Parameter of less than about 10.3. In certain embodiments, the polymer has a Fedors Solubility Parameter of about 9.8 to about 10.3, preferably of about 9.8 to about 10.2.

In some embodiments, the film constructions are as described above (e.g., composition, glass transition temperature, and/or Fedors Solubility Parameter), wherein the film construction removes cleanly from an aged surface that is rough, chalky, or a combination thereof after at least 5 years of installation on the surface, based on accelerated long term removability (LTR) protocol.

In certain embodiments of the film construction, the film construction removes cleanly from a smooth surface. In others embodiment of the film construction, the film construction removes cleanly from an aged, rough, or chalky surface or a combination thereof. In certain embodiments of the film construction, the film construction removes cleanly from an aged, rough, or chalky surface or a combination thereof after at least 5 years, preferably at least 10 years, of installation on said surface, based on accelerated long term removability (LTR) protocol. In certain embodiments of the film construction, the film construction wherein said film construction passes a 2-minute Cold Peel Test with at least 0.75 lbs. of peel, preferably at least 1.0 lbs. of peel.

A. Monomers

1. Monomer A

The polymers described herein contain monomer A. In some embodiments, the polymer contains about 40% by weight to about 90% by weight, based on the total weight of the polymer, of at least one monomer A having a glass transition temperature of no more than about 0° C., when polymerized as a homopolymer. In some embodiments, the polymer contains about 55% by weight to about 70% by weight, based on the total weight of the polymer, of monomer A.

In some embodiments, monomer A is a non-functionalized or functionalized monomer (such as, for example, with hydroxyl or carboxyl functional groups). Such monomers include, but are not limited to, butyl acrylate, 2-ethylhexyl acrylate, isooctyl acrylate, 4-hydroxy butyl acrylate, ethyl acrylate, n-hexyl acrylate, 2-propyl heptyl acrylate, hydroxyl propyl acrylate, and the like, and combinations thereof.

2. Monomer B

The polymers described herein may further contain monomer B. In some embodiments, the polymer contains about 0% by weight to about 10% by weight, based on the total weight of the polymer, of at least one monomer B having a glass transition temperature of greater than about 0° C., when polymerized as a homopolymer, and a Fedors Solubility Parameter of no more than about 10.5, when calculated for a homopolymer of said monomer B. In some embodments, the polymer contains about 2% by weight to about 8% by weight, based on the total weight of the polymer, of monomer B.

In some embodiments, monomer B is a (methy)acrylate. In some embodiments, monomer B is an alkyl or cycloalkyl (meth)acrylate. In other embodiments, monomer B is styrene or substituted styrene. Exemplary (meth)acrylates include, but are not limited to, methyl methacrylate, ethyl methacrylate, n-butyl methacrylate, iso-butyl methacrylate, tert-butyl (meth)acrylate, cyclohexyl methacrylate, isobornyl (meth)acrylate, propyl methacrylate, and combinations thereof. Exemplary styrene monomers include, but are not limited to, α-methyl styrene.

3. Monomer C

In some embodiments, the polymer further contains monomer C. In some embodiments, the polymer contains about 0.5% by weight to about 45% by weight, based on the total weight of the polymer, of at least one monomer C having a glass transition temperature of greater than about 0° C., and a Fedors Solubility Parameter of greater than about 10.5, when calculated for a homopolymer of monomer C. In some embodiments, the polymer contains about 25% by weight to about 45% by weight, based on the total weight of the polymer, of monomer C.

In some embodiment, monomer C is selected from C₁-C₂₀ alkyl (meth)acrylate, vinyl monomer, and combinations thereof. In some embodiments, monomer C is selected from C₁-C₄ alkyl (meth)acrylate, vinyl acetate, styrene, (meth)acrylic acid, (meth)acrylic anhydride, maleic anhydride, and combinations thereof. In other embodiments, monomer C is selected from methyl acrylate, glycidyl (meth)acrylate, (meth)acrylic acid, maleic anhydride, and combinations thereof.

In some embodiments, monomer C contains a functional group capable of crosslinking. In some embodiments, the functional group capable of crosslinking is selected from hydroxyl, carboxyl, organic diacid anhydride, silyl, carbonyl, carbonate ester, isocyanato, epoxy, vinyl, anhydride, mercapto, acid, acetoacetyl groups, and combinations thereof. For monomer C, the functional group capable of crosslinking excludes those monomers that contain a nitrogen-containing functional group, such amino, amide, imide, cyano functional group, and the like.

4. Monomer D

The polymers described herein may further contain monomer D. In some embodiments, monomer D is a nitrogen-containing monomer. In some embodiments, monomer D is a nitrogen-containing monomer and the polymer contains from about 0% by weight to about 30% by weight, based on the total weight of the polymer, of at least one monomer D having a glass transition temperature of greater than about 0° C. In some embodiments, monomer D is a nitrogen-containing monomer, the polymer contains from about 0% by weight to about 30% by weight, based on the total weight of the polymer, of at least one monomer D having a glass transition temperature of greater than about 0° C. and a Fedors Solubility Parameter of greater than about 10.5, when calculated for a homopolymer of monomer D. In some embodiments, monomer D is as defined above and the polymer contains about 1% by weight to about 15% by weight, based on the total weight of the polymer, of monomer D.

In some embodiments, monomer D is selected from N,N-dimethyl (meth)acrylamide, N,N-diethyl (meth)acrylamide, N,N-dipropyl acrylamide, N,N-dimethyl amino ethyl (meth) acrylamide, N,N-dimethyl amino propyl (meth)acrylamide, N,N-diethyl amino ethyl (meth)acrylamide, N,N-diethyl amino propyl (meth)acrylamide, n-(C₁-C₈)alkyl acrylamide, and combinations thereof. In some embodiments, monomer D is selected from N,N-dimethyl (meth)acrylamide, N,N-diethyl (meth)acrylamide, N,N-dipropyl acrylamide, N,N-dimethyl amino ethyl acrylamide, N,N-dimethyl amino propyl (meth)acrylamide, N,N-diethyl amino ethyl acrylamide, N,N-diethyl amino propyl (meth)acrylamide, and combinations thereof.

In some embodiments, the polymer is a copolymer containing at least 2-ethyl hexyl acrylate, methyl acrylate, (meth)acrylic acid, optionally methyl methacrylate, and optionally N,N-dimethyl acrylamide.

B. Backing Films and Coatings

In some embodiments the construction contains a backing film. In some embodiments, the backing film(s) useful in the film constructions described herein include those materials typically used in graphics applications. In some embodiments, the backing film is a film selected from polyvinyl chloride (PVC), plasticized polyvinyl chloride, acrylic (i.e., polyacrylate(s)), polyolefin (polyethylene, polypropylene, and copolymers thereof), polyurethane, fluoropolymer, polyester, cellulose ester, acetals, and blends thereof. In certain embodiments, the backing film is multi-layer and the various layers that may be the same or different.

The films described herein can be formed from a wide array of techniques including, but not limited to, extrusion and calendering processes. In some embodiments, the films have a thickness of at least about 10 microns and typically within a range of from about 20 microns to about 300 microns or more. Thus, it will be understood that the films can exhibit a thickness greater than 300 microns.

In some embodiments, the backing film used in the film construction may be coated with one or more coating layers. The term “coating” as used herein refers to a coating disposed on and in direct contact with an underlying backing film or other layer. Typically, coatings are initially in a liquid or flowable state; deposited or applied on the underlying backing film or other layer; and then cured or otherwise solidified. For applications in which the coating is formed into a film, the film is typically independent from an underlying film or other layer. In many versions, backing films as described herein are free standing films. However, films formed from the coating as described herein may be positioned alongside or in conjunction with the backing film or other layers. The coating may have a thickness or coating weight greater than 1 g/m² (gsm) and typically within a range of from 1 gsm to 30 gsm. In certain embodiments, the coatings have a thickness or coating weight within a range of from 5 gsm to 30 gsm. However, it will be understood that the coatings may have thicknesses or coating weights less than 1 gsm, and/or greater than 30 gsm.

Coatings of the compositions can be formed using a wide array of techniques. Upon depositing the composition upon a surface of interest, the layer of composition dries, hardens, and/or otherwise cures to form a coating. After deposition of the composition and during or after formation of the coating, one or more post-deposition treatments may be utilized such as exposure to radiation or heat.

In some embodiments, the coatings or films undergo polymerization and/or crosslinking during preparation or deposition. In some embodiments, one or more of the components in the composition undergoes polymerization.

In some embodiments, the film construction includes an optional coating, such a ultraviolet curing clear coating. In some embodiments, the film construction includes an optional release liner. In some embodiments, the film construction includes an optional ink layer, such as turbo, latex, ultraviolet, eco-sol or the like inks. In some embodiments, the film construction includes an optional transfer tape, such a paper transfer tape or the like.

C. Additives

The pressure sensitive adhesive compositions may contain one or more additives. Exemplary additives include, but are not limited to, pigments, colors or colorants, fillers, plasticizer, diluents, antioxidants, UV absorbers, tackifiers, and the like, and combinations thereof.

1. Tackifiers

In some embodiments, the pressure sensitive adhesive composition may contain a tackifier. A wide variety of tackifiers can be used to enhance the tack and peel of the adhesive. These include, but are not limited to, rosins and rosin derivatives including rosinous materials that occur naturally in the oleoresin of pine trees, as well as derivatives thereof including rosin esters, modified rosins such as fractionated, hydrogenated, dehydrogenated, and polymerized rosins, modified rosin esters and the like.

There may also be employed terpene resins which are hydrocarbons of the formula C₁₀ H₁₆, occurring in most essential oils and oleoresins of plants, and phenol modified terpene resins like α-pinene, β-pinene, dipentene, limonene, myrecene, bornylene, camphene, and the like. Various aliphatic hydrocarbon resins like Escorez 1304, manufactured by Exxon Chemical Co., and aromatic hydrocarbon resins based on C₉, C₅, dicyclopentadiene, coumarone, indene, styrene, substituted styrenes and styrene derivatives and the like can also be used.

Hydrogenated and partially hydrogenated resins such as Regalrez 1018, Regalrez 1033, Regalrez 1078, Regalrez 1094, Regalrez 1126, Regalrez 3102, Regalrez 6108, etc., produced by Eastman Chemical Company, can be used. Various terpene phenolic resins of the type SP 560 and SP 553, manufactured and sold by Schenectady Chemical Inc., Nirez 1100, manufactured and sold by Reichold Chemical Inc., and Piccolyte S-100, manufactured and sold by Hercules Corporation, are particularly useful tackifiers for the present invention. Various mixed aliphatic and aromatic resins, such as Hercotex AD 1100, manufactured and sold by Hercules Corporation, can be used.

While the resins described above are useful for tackifying the polymers described herein, the particular tackifying resin and/or amount selected for a given formulation may depend upon the type of acrylic polymer being tackified. Many resins which are known in the prior art as being useful for tackifying acrylic based pressure sensitive adhesives can be effectively used herein, although the scope of this disclosure is not limited to only such resins. Resins described in Satas, Handbook of Pressure Sensitive Adhesive Technology, Von Nostrand Reinhold, Company, Chapter 20, pages 527-584 (1989) (incorporated by reference herein) may be used.

The amount of tackifier used is dependent upon the type of copolymer and tackifier used. Typically, pressure-sensitive adhesive compositions described herein contain from about 5 to about 60% by weight of the composition of one or more tackifiers.

In one embodiment, the tackifier has a ring and ball softening point of from about 100° C. to about 150° C. In one embodiment, the tackifier is a terpene phenolic tackifier having a ring and ball softening point of from about 110° C. to about 120° C.

In another embodiment, the added resin may serve a dual purpose. For example, a resin such as Wingstay L*, a butylated reaction product of para-cresol and dicyclopentadiene with an average molecular weight of 650 produced by Eliokem, can serve both as a tackifier and an antioxidant.

2. Pigments

The compositions described herein may contain one or more pigments. Pigments, if desired, are provided in an amount sufficient to impart the desired color to the adhesive. Examples of pigments include, without limitation, solid inorganic fillers such as carbon black, titanium dioxide and the like, and organic dyes.

3. Other Additives

Other additives may be included in the pressure sensitive adhesives to impart desired properties. For example, plasticizers may be included, and they are known to decrease the glass transition temperature of an adhesive composition containing elastomeric polymers. Antioxidants also may be included in the adhesive compositions. Cutting agents such as waxes and surfactants also may be included in the adhesives. Light stabilizers, heat stabilizers, and UV absorbers also may be included in the adhesive compositions. Ultraviolet absorbers include benzo-triazol derivatives, hydroxy benzyl phenones, esters of benzoic acids, oxalic acid, diamides, and the like. Light stabilizers include hindered amine light stabilizers, and the heat stabilizers include dithiocarbamate compositions such as zinc dibutyl dithiocarbamate.

D. Exemplary Constructions

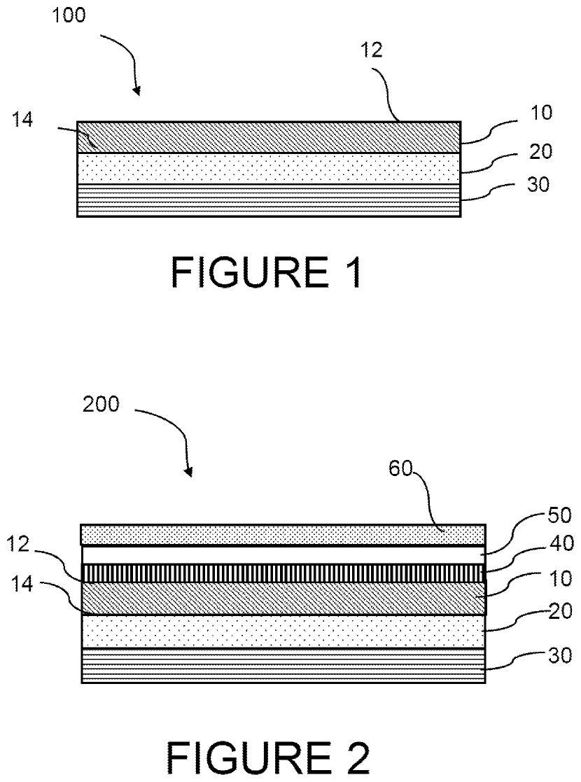

FIG. 1 illustrates a non-limiting, exemplary film construction as described herein. The film construction 100 includes a backing layer 10, pressure sensitive adhesive layer 20, and optional release liner 30, as described herein (and not shown to scale). The backing film 10 defines a first face 14 and an oppositely directed second face 12. The backing film is shown as a single layer but may be multilayer. The pressure sensitive adhesive layer 20 is applied over at least a portion of the first face 14. The pressure sensitive adhesive layer is shown as a single layer but may be multilayer.

FIG. 2 illustrates a non-limiting, exemplary film construction as described herein. The film construction 200 includes a backing layer 10 (2 mil PVC, for example), pressure sensitive adhesive layer 20 (applied at 33.5 gsm, for example), optional release liner 30 (90 #air egress liner sold under the EZ RS brand, for example), optional ink layer 40 (such as turbo, latex, UV, or eco-sol ink, for example), optional coating layer 50 (such as an 8 μm UV clearcoat, for example) and an optional transfer tape 60 (such as a paper transfer tape), as described herein (and not shown to scale). The backing film 10 defines a first face 14 and an oppositely directed second face 12. The backing film is shown as a single layer but may be multilayer. The pressure sensitive adhesive layer 20 is applied over at least a portion of the first face 14. The pressure sensitive adhesive layer is shown as a single layer but may be multilayer. If a coating is present, the first face 12 is typically an outer or exterior face of the coating, and the second face 14 is typically directed toward and/or contacting the underlying backing film (shown as a single layer but may be multilayer).

The pressure sensitive adhesive may be formed into a single layer or contain multiple layers of adhesive. The multiple layers of adhesive may be applied to the film or laminate simultaneously using methods known in the art. Examples of suitable adhesive coating methods include slot die coating, bullnose coating, reverse roll coating and the like.

### III. Methods of Making

A. Pressure Sensitive Adhesive Compositions

1. Polymers

The polymers can be prepared using any radical polymerization process including, but not limited to, solvent-based, emulsion, syrup, and bulk processes.

In principle, any living or controlled polymerization technique can be utilized to make the polymers useful in the pressure sensitive adhesives described herein. However, for the practicality of controlling acrylics, the polymers useful in the pressure sensitive adhesives described herein may be formed by controlled radical polymerization (CRP). These processes generally combine a free-radical initiator with a compound to control the polymerization process and produce polymers of a specific composition, and having a controlled molecular weight and narrow molecular weight range. The free-radical initiators used may be those known in the art, including, but not limited to, peroxy compounds, peroxides, hydroperoxides and azo compounds which decompose thermally to provide free radicals. In one embodiment the initiator may also contain the control agent.

Examples of controlled radical polymerization techniques will be evident to those skilled in the art, and include, but are not limited to, atom transfer radical polymerization (ATRP), reversible addition fragmentation chain transfer polymerization (RAFT), nitroxide-mediated polymerization (NMP), boron-mediated polymerization, and catalytic chain transfer polymerization (CCT). Descriptions and comparisons of these types of polymerizations are described in the ACS Symposium Series 768 entitled Controlled/Living Radical Polymerization: Progress in ATRP, NMP, and RAFT, edited by Krzystof Matyjaszewski, American Chemical Society, Washington, D.C., 2000.

In some embodiments, the polymers are prepared by controlled radical polymerization, such as nitroxide-mediated CRP. Nitroxide-mediated polymerization can occur in bulk, solvent, and aqueous polymerization, can be used in existing equipment at reaction times and temperature similar to other free radical polymerizations. One advantage of nitroxide-mediated CRP is that the nitroxide is generally innocuous and can remain in the reaction mix, while other CRP techniques require the removal of the control compounds from the final polymer.

2. Optional Crosslinking Agent

The polymer may be crosslinked during post curing of the polymer to increase its cohesive strength. This can be achieved via covalent crosslinking such as heat, actinic or electron beam radiation, or metal based ionic crosslinking between functional groups. Table 1 below lists the types of crosslinkers for the various functional groups of the polymer.

TABLE 1

| Functional Group Capable of Crosslinking | |
|---|---|
| of Monomer C (except where noted) | Crosslinker |
| Silane | Self-reactive |
| Hydroxyl | Isocyanate, melamine formaldehyde, anhydride, epoxy, |
| | titanium esters and chelates |
| Carboxylic acid, phosphoric acid | Aziridines, isocyanate, melamine formaldehyde, anhydride, |
| | epoxy, carboiimides, metal chelates, titanium esters, and |
| | oxazolines |
| Isocyanate | Self-reactive, carboxylic acid, amine, hydroxyl |
| Vinyl | Addition reaction with silicone hydride |
| (Meth)acrylate | Amine, mercaptan, self-reactive with radical catalyst (UV, |
| | thermal), acetoacetate |
| Epoxy | Amine, carboxylic acid, phosphoric acid, hydroxyl, mercaptan |
| Amine (in monomer D only; not in | Isocyanate, melamine formaldehyde, anhydride, epoxy, |
| monomer C) | acetoacetate |
| Mercapto | Isocyanate, melamine formaldehyde, anhydride, epoxy |
| Acetoacetate | Acrylate, amine |

Suitable polyfunctional aziridines include, for example, trimethylolpropane tris[3-aziridinylpropionate]; trimethylolpropane tris[3-(2-methylaziridinyl) propionate]; trimethylolpropane tris[2-aziridinylbutyrate]; tris(1-aziridinyl)-phosphine oxide; tris(2-methyl-1-aziridinyl)phosphine oxide; penta-erythritoltris[3-(1-aziridinyl)propionate]; and pentaerythritol tetrakis[3-(1-aziridinyl)propionate]. Combinations of more than one polyfunctional aziridine may also be used. Examples of commercially available polyfunctional aziridines include NEOCRYL CX-100 from Zeneca Resins, believed to be trimethylolpropaten tris[3-(2-methylaziridinyl)-propanoate], and Xama-2, Xama-7 and Xama-220 from Bayer Material Science.

Multifunctional aziridine amides which have the general formula:

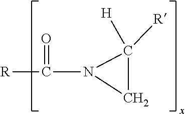

wherein R can be either an alkylene or aromatic group and R′ can be a hydrogen or alkyl group and x is at least 2 may be used. Examples of suitable multifunctional aziridine amides include 1,1′-(1,3-phenylenedicarbonyl)bis[2-methyl aziridine]; 2,2,4-trimethyladipoyl bis [2-ethyl aziridine]; 1,1′-azelaoyl bis [2-methyl aziridine]; and 2,4,6-tris(2-ethyl-l-aziridinyl)-1,3,5 triazine.

Metal chelate crosslinking agents may be compounds prepared by coordinating multivalent metals such as Al, Fe, Zn, Sn, Ti, Sb, Mg and V with acethylacetone or ethyl acetoacetonate.

Among the isocyanate crosslinking agents that can be used are aromatic, aliphatic and cycloaliphatic diisocyanates and triisocyanates. Examples include 2,4-toluene diisocyanate, m-phenylene diisocyanate, 4-chloro-1,3-phenylene diisocyanate, 3,3′-dimethyl-4,4′-diphenylene diisocyanate, 4,4′-diphenylene diisocyanate, xylene diisocyanate, 1,6-hexamethylene diisocyanate, 1,10-decamethylene diisocyanate, 1,4-cyclohexylene diisocyanate, 4,4′methylene bis(cyclohexyl isocyanate), 1,5-tetrahydronaphthalene diisocyanate, paraxylylene diisocyanate, durene diisocyante, 1,2,4-benzene diisocyanate, isoform diisocyanate, 1,4-tetramethylxylene diisocyanate, 1,5-naphthalene diisocyanate, or their reactants with polyol such as trimethylolpropane.

Other useful crosslinking agents include monomeric and polymeric melamine crosslinkers, such as Cymel 303 and 370 available from Cytec.

The crosslinking agent is typically used at a level from about 0.05% to about 5%, or from about 0.075% to about 2%, or from about 0.1% to about 1.5% by weight of adhesive solids.

Anhydride functional segmented polymers may be converted to silanes via a post polymerization reaction with amino-, mercapto- or hydroxyl-functional silanes. Examples of amino group-containing alkoxysilanes having a primary amino group alone as a reactive group include aminoalkyltrialkoxysilanes such as aminomethyltrimethoxysilane, aminomethyltriethoxysilane, β-amino-ethyltrimethoxysilane, β-aminoethyltriethoxysilane, γ-aminopropyltrimeth-oxysilane, γ-aminopropyltriethoxysilane, γ-aminopropyltripropoxysilane, γ-aminopropyltriisopropoxysilane, and γ-aminopropyltributoxysilane; (aminoalkyl)-alkyldialkoxysilanes such as β-aminoethylmethyldimethoxysilane, γ-amino-ethylmethyldiethoxysilane, γ-aminopropylmethyldimethoxysilane, γ-aminopropyl-methyldiethoxysilane, and γ-aminopropylmethyldipropoxysilane; and corresponding aminoalkyldialkyl(mono)alkoxysilanes.

Examples of amino group-containing alkoxysilanes having a primary amino group and a secondary amino group as reactive groups include N-(aminoalkyl)aminoalkyltrialkoxysilanes such as N-β-(aminoethyl)-γ-aminopropyl-trimethoxysilane and N-β-(aminoethyl)-γ-aminopropyltriethoxysilane; and N-(aminoalkyl)aminoalkylalkyldialkoxysilanes such as N-β-(aminoethyl)-γ-amino-propylmethyldimethoxysilane and N-β-(aminoethyl)-γ-aminopropylmethyl-diethoxysilane.

Examples of amino group-containing alkoxysilanes having a secondary amino group alone as a reactive group include N-phenylamino-methyltrimethoxysilane and N-phenyl-β-aminoethyltrialkoxysilanes such as N-phenyl-β-aminoethyltrimethoxysilane and N-phenyl-β-aminoethyltriethoxysilane; N-phenyl-γ-aminopropyltrialkoxysilanes such as N-phenyl-γ-aminopropyltrimethoxysilane, N-phenyl-γ-aminopropyltriethoxysilane, N-phenyl-γ-aminopropyltripropoxysilane, and N-phenyl-γ-aminopropyltributoxysilane; corresponding N-phenylaminoalkyl(mono- or di-)alkyl(di- or mono-) alkoxysilanes; as well as N-alkylaminoalkyltrialkoxysilanes corresponding to the above-listed amino group-containing alkoxysilanes having a secondary amino group substituted with phenyl group, such as N-methyl-3-aminopropyltrimethoxysilane, N-ethyl-3-aminopropyltrimethoxysilane, N-n-propyl-3-aminopropyltrimethoxysilane, N-n-butyl-aminomethyltrimethoxysilane, N-n-butyl-2-aminoethyltrimethoxysilane, N-n-butyl-3-aminopropyltrimethoxysilane, N-n-butyl-3-aminopropyltriethoxysilane, and N-n-butyl-3-aminopropyltripropoxysilane, and corresponding N-alkylaminoalkyl(mono- or di-)alkyl(di- or mono)alkoxysilanes. Others include N-cyclohexylaminomethylmethyldiethoxy silane and N-cyclohexylaminomethyl-triethoxysilane.

Examples of the mercapto group-containing silanes include mercaptoalkyltrialkoxysilanes such as mercaptomethyltrimethoxysilane, mercaptomethyltriethoxysilane, β-mercaptoethyltrimethoxysilane, β-mercapto-ethyltriethoxysilane, β-mercaptoethyltripropoxysilane, β-mercaptoethyl-triisopropoxysilane, β-mercaptoethyltributoxysilane, γ-mercaptopropyl-trimethoxysilane, γ-mercaptopropyltriethoxysilane, γ-mercaptopropyltri-propoxysilane, γ-mercaptopropyltriisopropoxysilane, and γ-mercapto-propyltributoxysilane; (mercaptoalkyl)alkyldialkoxysilanes such as β-mercaptoethylmethyldimethoxysilane, β-mercaptoethylmethyldiethoxysilane, γ-mercaptopropylmethyldimethoxysilane, γ-mercaptopropylmethyldiethoxysilane, γ-mercaptopropylmethyldipropoxysilane, β-mercaptopropylmethyldiisopropoxy-silane, -mercaptopropylmethyldibutoxysilane, γ-mercaptopropylethyldimethoxy-silane, γ-mercaptopropylethyldiethoxysilane, γ-mercaptopropylethyldipropoxy-silane, γ-mercaptopropylethyldiisopropoxysilane, and γ-mercaptopropyl-ethyldibutoxysilane; and corresponding (mercaptoalkyl)dialkyl(mono)-alkoxysilanes.

Examples of hydroxyl-functional silanes include hydroxymethyltrialkoxy silanes having the formula:

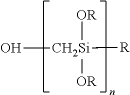

where R is an alkyl group and n is at least 1. The alkyl group is preferably a lower alkyl group having 1 to 6 carbon atoms, and preferably 1 to 3 carbon atoms. Particularly useful are the silanes in which the alkyl group is methyl or ethyl, namely hydroxymethyltriethoxysilane and hydroxymethyltriethoxysilane when n=1.

Carboxylic acid, hydroxyl, or epoxy are preferred functional groups capable of crosslinking. Preferred crosslinkers are metal chelates, aziridines, isocyanates, and epoxies.

In some embodiments, the polymers useful in the pressure sensitive adhesives of the invention have a controlled molecular weight and molecular weight distribution. In some embodiments. The weight-average molecular weight (M_{w}) of the copolymer is from 1,000 to 1,000,000 g/mol, and most preferably from 5,000 to 300,000 g/mol. The molecular weight distribution, as measured by M_{w}/Mₙ or polydispersity, is generally less than 6.0, and preferably below 4.0.

### IV. Methods of Use

The film constructions described herein may be used in many graphics applications, including, but not limited to, as large sheets/panels applied to vehicles or other exterior surface(s), such as building exteriors, billboards, or other structures.

In other embodiments, methods of protecting a surface including applying the film construction to the surface are also described. In some embodiments, the surface is a smooth surface. In other embodiments of the film constructions and methods, the surface is an aged, rough, or chalky surface, or a combination thereof.

In other embodiments, the film construction removes cleanly after at least 5 years, preferably at least 7 years, and more preferably at least 10 years, of installation on the surface, based on accelerated aging testing in accordance with ISO 4892-2 (2013) protocol; whether or not the surface was originally smooth. For example, the film constructions described herein remove cleanly, whether or not the surface was originally new and/or smooth or used (which could be smooth or aged, rough, or chalky or a combination thereof.

Depending upon the application, the surface may contain or include at least one material selected from unpainted metal, painted metal, glass, and fiberglass. Typically, the metal is aluminum, such as the painted aluminum panels used in fleet trucks.

The constructions and methods described herein is further defined in the following Examples, in which all parts and percentages are by weight, unless otherwise stated. It should be understood that these examples, while indicating preferred embodiments of the invention, are given by way of illustration only. From the above discussion and these examples, one skilled in the art can ascertain the essential characteristics of the constructions and methods of making and using thereof, and without departing from the spirit and scope thereof, can make various changes and modifications of the invention to adapt it to various usages and conditions.

### EXAMPLES

The following test methods were used to evaluate exemplary embodiments and comparative materials, unless otherwise noted.

2-Minute Cold Peel Test: A painted aluminum substrate is placed into an environmental chamber set at 45′F. The film construction is laminated to the substrate with a 4-pound rover and allowed to dwell for 2 minutes; then pulled at a 180° angle at a rate of 12 inches per minute.

Accelerated Aging: The film construction is laminated to a painted aluminum (smooth) substrate; then placed into a xenon-arc Weather-Ometer® weathering instrument following ISO 4892-2 (2013) protocol. The substrate is removed from the Weather-Ometer® weathering instrument at various intervals and the film is pulled from the substrate.

Accelerated Long Term Removability (LTR): The film construction is laminated to a painted aluminum substrate, then placed into a forced air oven at 90° C. for 48 hours. The substrate is removed from the oven and pulled from the substrate by hand. The panel may be new/smooth or aged/rough/chalky. Additional testing may also be completed on actual fleet panels, including those that are aged, rough, and/or chalky.

Adhesion Testing: Adhesion testing procedures in accordance to 16th edition of “Test Methods for Pressure Sensitive Adhesive Tapes,” published by the Pressure Sensitive Tape Council.

Peel Test: 180° peels—PSTC 101—Adhesion to Painted Aluminum with various dwell times in climate controlled room and also applied heat aged (90° C. for 48 hours).

Tack Test: Loop Tack—PSTC 16—initial tack to painted aluminum.

Chalky Panel: A substrate designated as a “chalky panel” was provided by an external partner. A painted aluminum panel becomes chalky due to outdoor exposure over time. Outdoor exposure causes degradation of the paint to a state where it has partially degraded and forms a powder layer on the surface. There may also contain scratches, dents, and markings in the “chalky panel” caused by wear over time. Chalky panel removability testing includes typical field installation methods of applying the graphics film (usually 2 mil PVC) construction with pressure sensitive adhesive to a trailer, allowing the applied graphics film construction to dwell for a minimum of 30 minutes and then attempting to remove the applied graphics film via conventional removal methods (like peeling and the like) and evaluating the ease of such removal (including whether the applied graphics film construction removes a single or at least a few large pieces or as a large number of fragmented pieces.

### Example 1: Free Radical Polymerization

An acrylic copolymer was prepared as follows. Into a 1500 ml reactor equipped with a heating jacket, agitator, reflux condenser, feed tanks and nitrogen gas inlet there was charged

65.36 g 2-ethyl hexyl acrylate (2-EHA)

19.18 g N,N-dimethyl acrylamide (NNDMA)

2.61 g acrylic acid (AA)

30.58 g acetone

47.75 g ethyl acetate

The reactor was purged with nitrogen for approximately 0.5 hour at 0.5 liter/min while the mixture is heated via 95° C. jacket to a reflux under agitation. Monomers and solvents were added in the following amounts to a feed vessel and purged with nitrogen at 0.5 liter/min:

370.42 g 2-EHA

108.65 g NNDMA

14.81 g AA

136.19 g acetone

210.97 g ethyl acetate

0.76 g lauryl peroxide (LPO)

41.67 g toluene

At reflux temp of approximately 72° C., a mixture of 0.18 g of LPO and 8.84 g toluene was added to the reactor to initiate polymerization. The reaction was monitored until a peak temperature is reached at approximately 82° C., in which at peak temperature the monomer/solvent mixture in the feed vessel was added to the reactor over 2 hours at a constant rate of 7.01 g/min. Reflux was maintained throughout the feed in which the reaction temperature dropped to approximately 76° C. and held steady. At the completion of the reactive feed, the reaction was held for 30 minutes. During the 30-minute hold, a second feed was weighed out into another feed vessel fitted with Nitrogen purge. Into the second vessel, 1.64 g of t-amyl peroxy pivalate and 78.07 g of toluene were added. At the end of the 30-minute hold, the chase feed was added to the reactor over 60 minutes at a constant rate of 1.33 g/min. The chase feed polymerized any remaining residual monomer left over. At the completion of the chase feed, the reaction was held under reflux for 30 minutes. After the 30-minute hold, the resulting solution polymer was cooled and 362.32 g of ethyl acetate was added for dilution and cooling. At room temperature, the polymer was discharged and viscosity and solid content were measured.

### Example 2: Free Radical Polymerization

An acrylic copolymer was prepared as follows. Into a 100-gallon reactor equipped with a heating jacket, agitator, reflux condenser, feed tanks and nitrogen gas inlet there were charged through a nitrogen diffuser:

30.50 lbs. 2-EHA

8.95 lbs. NNDMA

1.22 lbs. AA

14.27 lbs. acetone

22.29 lbs. ethyl Acetate

The reactor was purged with nitrogen at 0.2 liter/min while the mixture was heated via 95° C. jacket to a reflux under agitation. Monomers and solvents were added in the following amounts to a feed vessel:

172.86 lbs. 2-EHA

50.70 lbs. NNDMA

6.91 lbs. AA

63.55 lbs. acetone

98.45 lbs. ethyl acetate

In a separate second feed vessel, an initiator solution was added in the following amounts

0.355 lbs. LPO

19.44 lbs. toluene

At reflux temperature of about 70° C., the reactor charge was purged for 10 minutes to deplete any oxygen left in the reactor. After the 10-minute hold, a mixture of 0.08 lbs. of LPO and 4.13 lbs. toluene were added to the reactor to initiate polymerization. The reaction was monitored until a peak temperature was reached at about 77° C., at which time the monomer/solvent mixture in the feed vessel was added to the reactor through a nitrogen diffuser over 2 hours at a constant rate of 3.27 lbs./min. At the same time (peak T), the initiator solution feed was added to the reactor through a Nitrogen diffuser over 2 hours at a constant rate of 0.17 lbs./min. Reflux was maintained throughout the feed in which the reaction temperature dropped to about 74° C. and held steady. At the completion of the reactive feed, the reaction was held for 30 minutes. During the 30-minute hold, a chaser feed was weighed out into a feed vessel. Into the second vessel, 0.77 lbs. of LPO and 36.43 lbs. of toluene were added. At the end of the 30-minute hold, the chase feed was added to the reactor over 60 minutes at a constant rate of 0.62 lbs./min. The chase feed polymerized any remaining residual monomer left over. At the completion of the chase feed, the reaction was held under reflux for 30 minutes. After the 30-minute hold, the resulting solution polymer was cooled and 314.00 lbs. of Ethyl Acetate was added for dilution and cooling. At room temperature, a crosslinking solution was added to the reactor in the following amounts:

1.09 lbs. aluminum acetyl acetonate

3.28 lbs. 2,4-pentanedione

9.84 lbs. toluene

Once fully mixed, the polymer was discharged and viscosity and solids content were measured.

### Example 3: Preparation of Film Constructions

The film constructions were prepared by coating the adhesive by slot die and bullnose coating onto a release liner and then drying the coated liner in an oven at 210° F. Examples of suitable alternative adhesive coating methods include slot die coating, bullnose coating, reverse roll coating and the like. The adhesive coat weight was approximately 33.5 gsm. After drying, the adhesive was laminated to a 2 mil polyvinyl chloride film.

Film constructions were prepared with the following polymer compositions:

| Comparative | | Polymerization | | | | | | | | |
|---|---|---|---|---|---|---|---|---|---|---|
| (C) or | | Method | | | | | | | | |
| invention (I) | Example | (Example 1 or 2) | Monomer A | | Monomer B | | Monomer C | | Monomer D | |
| C | 1D | 1 | EHA | 75 | | | AA | 3 | nnDMA | 22 |
| I | 2F | 1 | EHA | 88 | | | AA | 3 | nnDMA | 9 |
| | 2G | | | | | | | | | |
| C | 3C | 1 | EHA | 80 | | | AA | 3 | nnDMA | 17 |
| | 3D | | | | | | | | | |
| C | 6A | 1 | EHA | 76.25 | | | GMA | 0.75 | nnDMA | 23 |
| I | 13A | 1 | EHA | 84 | | | GMA | 1 | nnDMA | 15 |
| I | 16A | 1 | EHA | 88 | | | GMA | 1 | nnDMA | 11 |
| I | 18A | 1 | EHA | 80 | | | GMA | 1 | nnDMA | 19 |
| C | 19B | 1 | EHA | 75.5 | | | AA | 1.5 | nnDMA | 23 |
| | 19C | | | | | | | | | |
| I | 20C | 1 | EHA | 88.5 | | | AA | 1.5 | nnDMA | 10 |
| I | 21A | 1 | EHA | 81.5 | | | AA | 1.5 | nnDMA | 17 |
| | 21B | | | | | | | | | |
| I | 22C | 1 | EHA | 64.25 | MMA | 705 | MA/AA | 25/3 | | |
| I | 23C | 1 | EHA | 74 | MMA | 5.3 | MA/AA | 17.5/3 | | |
| I | 24C | 1 | EHA | 84 | MMA | 31 | MA/AA | 9.9/3 | | |
| C | 32A | 2 | EHA | 75 | | | AA | 3 | nnDMA | 22 |
| I | 33A | 2 | EHA | 64.23 | MMA | 7.75 | MA/AA | 25/3 | | |
| I | 34A | 2 | EHA | 84 | MMA | 31 | MA/AA | 9.9/3 | | |
| I | 35A | 2 | EHA | 88 | | | AA | 3 | nnDMA | 9 |
| I | 36A | 2 | EHA | 88.5 | | | AA | 1.5 | nnDMA | 10 |
| I | 37A | 2 | EHA | 81.5 | | | AA | 1.5 | nnDMA | 17 |
| C | CC1A | | | | | | | | | |
| | CC18 | Commercial | | | | | | | | |
| | CC1C | Control | N/A | | | | | | | |
| C | CC2 | Commercial | N/A | | | | | | | |
| | | Control | | | | | | | | |
| C | CC3 | Commercial | N/A | | | | | | | |
| | | Control | | | | | | | | |
| | | | | Comparative | | | | Crosslinker | | |
| | | | | (C) or | Viscosity | Fox T | | level ( based | | Release |
| | | | | invention (I) | (cps) | (° C.) | FSP | on solids) | Crosslinker | Liner |
| | | | | C | 26000 | −23 | 10.59 | 0.4 | AAA | FLAT |
| | | | | I | 3820 | −38 | 10.06 | 0.6 | AAA | EZ |
| | | | | | | | | 0.8 | AAA | EZ |
| | | | | C | 4120 | −29 | 10.4 | 0.5 | AAA | EZ |
| | | | | | | | | 0.6 | AAA | EZ |
| | | | | C | 3445 | −25 | 10.38 | 1.0 | Nacare 7231 | FLAT |
| | | | | I | 2940 | −34 | 10.05 | 1.0 | Nacure 7232 | EZ |
| | | | | I | 1774 | −38 | 9.87 | 1.0 | Nacure 7221 | EZ |
| | | | | I | 334 | −29 | 10.22 | 1.0 | Nacare 7231 | EZ |
| | | | | C | 6130 | −24 | 10.5 | 0.5 | AAA | EZ |
| | | | | | | | | 0.8 | AAA | EZ |
| | | | | I | 2030 | −38 | 9.98 | 0.8 | AAA | EZ |
| | | | | I | 4430 | −31 | 10.26 | 0.4 | AAA | EZ |
| | | | | | | | | 0.6 | AAA | EZ |
| | | | | I | 6090 | −26 | 10.1 | 0.8 | AAA | EZ |
| | | | | I | 4830 | −33 | 9.98 | 0.8 | AAA | EZ |
| | | | | I | 5910 | −40 | 9.85 | 0.8 | AAA | EZ |
| | | | | C | 2300 | −23 | 10.59 | 0.4 | AAA | EZRS |
| | | | | I | 1215 | −26 | 10.1 | 0.8 | AAA | EZRS |
| | | | | I | 1210 | −40 | 9.85 | 0.8 | AAA | EZRS |
| | | | | I | 1100 | −38 | 10.06 | 0.8 | AAA | EZRS |
| | | | | I | 850 | −38 | 9.96 | 0.8 | AAA | EZRS |
| | | | | I | 1500 | −31 | 10.26 | 0.4 | AAA | EZRS |
| | | | | C | | | | | | FLAT |
| | | | | | | | | | | EZRS |

| | | | | |
|---|---|---|---|---|
| N/A | −28 | 10.64 | N/A | EZRS |

| | | |
|---|---|---|
| C | N/A | EZRS |
| C | N/A | EZRS |

### Example 4: Representative Examples for Calculating FSP and T_{g}

Representative Examples of FSP Calculations for Homopolymers and Copolymers:

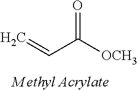

FSP for the homopolymer of poly(methyl acrylate) is calculated based on converted monomer structure—i.e. the double bond is converted to polymer.

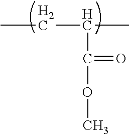

Thus, the group contribution breakdown is:

| Group | #/molecule | Δeᵢ (cal/mol) | Δvᵢ (cm³/mol) |
|---|---|---|---|
| CH₃ | 1 | 1125 | 33.5 |
| CH₂ | 1 | 1180 | 6.1 |
| CH | 1 | 820 | −1 |
| CO₂ | 1 | 4300 | 18 |
| Σ sum | | 7425 | 66.6 |

FSP calculation for MA=(ΣΔeᵢ/ΣΔvᵢ)^{0.5}=(7425/66.6)^{0.5}=10.56 (cal/cm³)^{0.5}

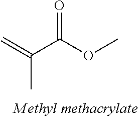

FSP for the homopolymer of poly(methyl methacylate) is calculated based on converted monomer structure—i.e. the double bond is converted to polymer.

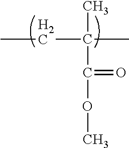

Thus, the group contribution breakdown is:

| Group | #/molecule | Δe (cal/mol) | Δvᵢ (cm³/mol) |
|---|---|---|---|
| CH3 | 2 | 1125 | 33.5 |
| CH2 | 1 | 1180 | 6.1 |
| CH | 1 | 350 | −19.2 |
| CO, | 1 | 4300 | 18 |
| Σ sum | | 8080 | 81.9 |

FSP calculation for MMA=(ΣΔeᵢ/ΣΔvᵢ)^{0.5}=(8080/81.9)^{0.5}=9.93 (cal/cm³)^{0.5}

Copolymer FSP

The FSP for a copolymer is the sum total of the products of the mole % for each individual monomer residue in the copolymer and the FSP for the individual monomers, calculated based on their homopolymer. For example, for a copolymer of 64.25/25/7.75/3 2-EHA/MA/MMA/AA the following calculation may be done:

Copolymer FSP=Σmol %*FSP=4.268+4.045+1.014+0.771=10.098 (cal/cm³)^{0.5}

Representative Example of Fox Equation Calculation for T_{g} of Copolymer:

| Monomer | T_{g} (° C/° K) | Weight % | Weight %/T_{g} |
|---|---|---|---|
| 2-EHA | −50/223 | 64.25 | 0.00288 |
| MA | +10/283 | 25 | 0.00088 |
| MMA | +105/378 | 7.75 | 0.00021 |
| AA | +106/379 | 3 | 0.00008 |
| Σ sum | | 100 | 0.00405 |

Copolymer T_{g}=(1/ΣWeight %/T_{g})−273=(1/0.00405)−273=246.92−273=−26° C.

### Example 5: Test Results

The test results for the PSA polymers tested are shown in three tables below where the following abbreviations are used:

| Abbreviation | Definition |
|---|---|
| M | minute |
| H | hour |
| WK | week |
| UP | unprinted |
| Fresh | material that was not heat aged |
| PA | painted aluminum |
| HA | heat aged |
| RT | room temperature |
| PR | printed |
| MD | machine direction |
| CD | cross direction |
| SS | stainless steel |
| LTR | long term removability |
| WPI | Williams plasticity index |

| | | Commercial Comparative Polymer Examples | | | | | | | | | | | | | | | | |
|---|---|---|---|---|---|---|---|---|---|---|---|---|---|---|---|---|---|---|
| EXAMPLE | | CC2 | CC3 | CC1A | CC1B | CC1C | | | | | | | | | | | | |
| | FoxT_{g} (° C.) | | | −28 | −28 | -28 | | | | | | | | | | | | |
| | FSP (cal/cm³)^{0.5} | | | 10.64 | 10.64 | 10.64 | | | | | | | | | | | | |
| | Face | PVC | PVC | PVC | PVC | PVC | | | | | | | | | | | | |
| | Liner | EZRS | EZRS | Flat | EZ | EZRS | | | | | | | | | | | | |
| | | (Structured) | (Structured) | | (Structured) | (Structured) | | | | | | | | | | | | |
| Peel | 2M/UP/FRESH/PA | 2.3 | 1.8 | 1.4 | 1.5 | 1.1 | | | | | | | | | | | | |
| | 15M/UP/FRESH/PA | 2.5 | 1.9 | 1.8 | 1.4 | 1.3 | | | | | | | | | | | | |
| | 24H/UP/FRESH/PA | 2.6 | 2.5 | 2.7 | 1.6 | 1.7 | | | | | | | | | | | | |
| | 1WK/UP/FRESH/PA | 2.7 | 2.9 | 2.2 | 2.1 | 2.6 | | | | | | | | | | | | |
| | 2M/PR/FRESH/PA | 1.3 | 1.3 | 1.4 | 1.2 | 1.1 | | | | | | | | | | | | |
| | 15M/PR/FRESH/PA | 1.2 | 1.6 | 1.4 | 1.3 | 1.2 | | | | | | | | | | | | |
| | 24H/PR/FRESH/PA | 1.8 | 2.1 | 1.8 | 1.4 | 1.6 | | | | | | | | | | | | |
| | 1WK/PR/FRESH/PA | 1.7 | 2.3 | 1.9 | 1.8 | 2.5 | | | | | | | | | | | | |
| | 2WK60C/UP/FRESH/ | 3.8 | 4.1 | 4.6 | 5.1 | 5.1 | | | | | | | | | | | | |
| | PA | | | | | | | | | | | | | | | | | |
| | 2WK60C/PR/FRESH/ | 3.7 | 4.3 | 5.1 | 5.1 | 4.7 | | | | | | | | | | | | |
| | PA | | | | | | | | | | | | | | | | | |
| | 2M/UP/HA/PA | 1.7 | 1.5 | 1.6 | 1.3 | 1 | | | | | | | | | | | | |
| | 15M/UP/HA/PA | 1.9 | 1.8 | 1.5 | 1.4 | 1.5 | | | | | | | | | | | | |
| | 24H/UP/HA/PA | 2.2 | 2.2 | 1.7 | 1.7 | 1.6 | | | | | | | | | | | | |
| | 1WK/UP/HA/PA | 2.4 | 2.2 | 2.4 | 1.9 | 2 | | | | | | | | | | | | |
| Tack | UP/FRESH/RT/PA | 1.5 | 0.8 | 1.9 | 1.7 | 1.1 | | | | | | | | | | | | |
| | UP/HA/RT/PA | 1.2 | 0.8 | 2 | 1.4 | 1.4 | | | | | | | | | | | | |
| | UP/FRESH/60F/PA | 2.2 | 0.2 | 2.2 | 1.5 | 1.2 | | | | | | | | | | | | |
| | UP/FRESH/45F/PA | 2.4 | 0.2 | 0.9 | 0.7 | 0.6 | | | | | | | | | | | | |
| | PR/FRESH/RT/PA | 1.4 | 1.4 | 2 | 1.8 | 1.2 | | | | | | | | | | | | |
| | PR/FRESH/60F/PA | 1.7 | 0.9 | 2.5 | 2.1 | 1.6 | | | | | | | | | | | | |
| | PR/FRESH/45F/PA | 2.1 | 0.5 | 1.4 | 1.2 | 0.9 | | | | | | | | | | | | |
| Shear | UP/FRESH/RT/SS | 121.3 | 156.3 | 6960.7 | 1371.4 | 2240 | | | | | | | | | | | | |
| | UP/HA/RT/SS | 54.8 | 12.1 | 2774.1 | 487 | 240.3 | | | | | | | | | | | | |
| | PR/FRESH/RT/SS | 31.3 | 27.2 | 8648.6 | | 1287 | | | | | | | | | | | | |
| Rivet | UP/MD | 0.1 | 0.1 | 0.1 | | 0.1 | | | | | | | | | | | | |
| | UP/CD | 0.1 | 0.1 | 0.1 | | 0.1 | | | | | | | | | | | | |
| | PR/MD | 0.1 | 0.1 | 0.1 | | 0.1 | | | | | | | | | | | | |
| | PR/CD | 0.1 | 0.1 | 0.1 | | 0.1 | | | | | | | | | | | | |
| Accelerated | UP | 172 | 152 | 146 | | 104 | | | | | | | | | | | | |
| LTR | PR | 175 | 150 | 151 | | 133 | | | | | | | | | | | | |
| | TOTAL (UP AND | 347 | 302 | 297 | 0 | 237 | | | | | | | | | | | | |
| | PR) | | | | | | | | | | | | | | | | | |
| WOM LTR | UP-2000 HR | 161 | 147 | 105 | 93 | | | | | | | | | | | | | |
| | PR-2000 HR | 141 | | 75 | | | | | | | | | | | | | | |
| | TOTAL-2000 HR | 302 | | 180 | 0 | 0 | | | | | | | | | | | | |
| WPI | | | | 4.35 | 4.35 | 4.35 | | | | | | | | | | | | |
| 24 hour Peel | FRESH 24 HR 80″/ | | | | | | | | | | | | | | | | | |
| | min PA | | | | | | | | | | | | | | | | | |
| Heat Aged Peel | AGED 80″/min PA | 5.53 | | | | | | | | | | | | | | | | |
| Tent | 24 hour | 15.3 | | 20 | 20 | 20 | | | | | | | | | | | | |
| Chalky Panel | | POOR | GOOD | | | POOR | | | | | | | | | | | | |
| | | Commercial Comparative Polymer Examples | | | | | | | | | | | | | | | | |
| EXAMPLE | | 1D | 6A | 16A | 18A | 13A | 3C | 2F | 19B | 2G | 20C | 3D | 21A | 22C | 23C | 24C | 21B | 19C |
| | Fox T_{g} (° C.) | −23 | −25 | −38 | −29 | −34 | −29 | −38 | −24 | −38 | −38 | −29 | −31 | −26 | −33 | −40 | −31 | −24 |
| | FSP (cal/cm³)^{0 5} | 10.59 | 10.39 | 9.87 | 10.22 | 10.05 | 10.4 | 10.06 | 10.5 | 10.06 | 9.96 | 10.4 | 10.26 | 10.1 | 9.98 | 9.85 | 10.26 | 10.5 |
| | Face (PVC) | PVC | PVC | PCV | PVC | PVC | PVC | PVC | PVC | PVC | PVC | PVC | PVC | PVC | PVC | PVC | PVC | PVC |
| | Liner | Flat | Flat | EZ | EZ | EZ | EZ | EZ | EZ | EZ | EZ | EZ | EZ | EZ | EZ | EZ | EZ | EZ |
| | | | | (struc- | (struc- | (struc- | (struc- | (struc- | (struc- | (struc- | (struc- | (struc- | (struc- | (struc- | (struc- | (struc- | (struc- | (struc- |
| | | | | tured) | tured) | tured) | tured) | tured) | tured) | tured) | tured) | tured) | tured) | tured) | tured) | tured) | tured) | tured) |
| Peel | 2M/UP/FRESH/PA | 2.7 | 3.1 | 1.4 | 1.9 | 1.5 | 2.2 | 2.1 | 1.9 | 1.3 | 1.5 | 1.5 | 2.1 | 1.4 | 1.6 | 1.2 | 1.9 | 1.9 |
| | 15M/UP/FRESH/PA | 2.8 | 3.2 | 1.3 | 1.8 | 1.6 | 2.5 | 2 | 2.3 | 1.6 | 1.5 | 1.8 | 2.1 | 1.5 | 1.7 | 1.3 | 2.1 | 2.1 |
| | 24H/UP/FRESH/PA | 3.6 | 3.4 | 1.5 | 2.3 | 1.6 | 2.7 | 2.1 | 2.6 | 1.7 | 1.7 | 1.9 | 2.4 | 1.8 | 2.1 | 1.6 | 2.3 | 2.3 |
| | 1WK/UP/FRESH/PA | 3.4 | 4.9 | 1.5 | 2.2 | 1.9 | 2.8 | 2.5 | 2.6 | 1.7 | 1.7 | 2 | 2.4 | 1.9 | 2.3 | 1.7 | 2.3 | 2.4 |
| | 2M/PR/FRESH/PA | 1.8 | 1.9 | 0.8 | 1.1 | 0.9 | 1.5 | 1.1 | 1.5 | 0.9 | 1 | 1.1 | 1.5 | 0.9 | 1.2 | 0.7 | 1.2 | 1.1 |
| | 15M/PR/FRESH/PA | 2 | 2.1 | 0.8 | 1.1 | 1 | 1.7 | 1.4 | 1.3 | 1 | 0.9 | 1.4 | 1.5 | 0.9 | 1.2 | 0.7 | 1.2 | 1.4 |
| | 24H/PR/FRESH/PA | 2.5 | 2.8 | 0.9 | 1.3 | 1 | 2.1 | 1.4 | 1.8 | 1 | 1 | 1.3 | 1.7 | 1 | 1.5 | 1.2 | 1.7 | 1.6 |
| | 1WK/PR/FRESH/PA | 3.8 | 4.1 | 1.1 | 1.7 | 1.3 | 2.3 | 2 | 2.1 | 1.1 | 1 | 1.4 | 1.8 | 1.2 | 1.6 | 1.2 | 1.7 | 1.8 |
| | 2WK60C/UP/FRESH/ | 4.5 | 5.1 | 1.5 | 2.1 | 1.9 | 3.1 | 2.6 | 4.2 | 2.4 | 2.6 | 3 | 3.7 | 2.6 | 3 | 2.7 | 3.6 | 3.9 |
| | PA | | | | | | | | | | | | | | | | | |
| | 2WK60C/PR/FRESH/ | 5 | 5.1 | 1.6 | 2.2 | 1.8 | 3.2 | 2.4 | 4.1 | 2.3 | 2.4 | 2.9 | 3.3 | 2.5 | 2.7 | 2.5 | 3.4 | 3.6 |
| | PA | | | | | | | | | | | | | | | | | |
| | 2M/UP/HA/PA | 2.5 | 2.5 | 1 | 1.6 | 1.3 | 1.8 | 1.5 | 1.6 | 1.2 | 1 | 1.2 | 1.8 | 1.2 | 1.4 | 1 | 1.5 | 1.7 |
| | 15M/UP/HA/PA | 2.4 | 2.6 | 1.1 | 1.7 | 1.4 | 2.1 | 1.7 | 2.3 | 1.5 | 1.6 | 1.6 | 2 | 1.5 | 1.6 | 1.1 | 1.7 | 1.8 |
| | 24H/UP/HA/PA | 3 | 3.4 | 1.1 | 1.8 | 1.3 | 2.3 | 1.5 | 2.7 | 1.8 | 1.6 | 1.9 | 2.4 | 1.9 | 2.1 | 1.6 | 2.3 | 2.4 |
| | 1WK/UP/HA/PA | 3.2 | 3.5 | 1.1 | 1.8 | 1.4 | 2.4 | 1.7 | 2.5 | 1.6 | 1.6 | 1.9 | 2.3 | 1.9 | 2.2 | 1.4 | 2.2 | 2.3 |
| Tack | UP/FRESH/RT/PA | 3.2 | 4 | 2 | 2.7 | 2.5 | 3.4 | 3.2 | 3.3 | 2.5 | 2.5 | 2.9 | 2.9 | 2.2 | 2.2 | 1.9 | 2.9 | 3.1 |
| | UP/HA/RT/PA | 3.2 | 3.9 | 1.8 | 2.7 | 2.1 | 3.1 | 2.7 | 3.3 | 2.5 | 2.3 | 2.7 | 3 | 2.5 | 2.3 | 1.8 | 2.9 | 3 |
| | UP/FRESH/60F/PA | 2.5 | 5.4 | 2.9 | 3.7 | 3.4 | 4.3 | 4.1 | 4.5 | 3.2 | 3.5 | 3.8 | 4.8 | 3.2 | 3.1 | 2.9 | 4.2 | 4.5 |
| | UP/FRESH/45F/PA | 1.9 | 2.8 | 4 | 5.2 | 4 | 2 | 4.4 | 1.8 | 4.2 | 4.5 | 3.7 | 4.8 | 3.7 | 3.7 | 3.3 | 4.4 | 3.4 |
| | PR/FRESH/RT/PA | 2.6 | 2.8 | 1.6 | 2 | 1.8 | 2.5 | 2.2 | 3 | 2 | | 2.3 | 2.6 | 1.9 | 2 | 1.6 | 2.7 | 2.7 |
| | PR/FRESH/60F/PA | 4.2 | 4.8 | 2.1 | 2.8 | 2.5 | 3.6 | 3.2 | 3.8 | 2.5 | 2.4 | 3 | 3.3 | 2.4 | 2 | 2.3 | 3.1 | 3.3 |
| | PR/FRESH/45F/PA | 2.1 | 5.2 | 2.9 | 3.9 | 3.2 | 4 | 3.7 | 3.8 | 2.8 | 2.9 | 3.4 | 3.9 | 3 | 2.6 | 2.5 | 3.4 | 3.7 |
| Shear | UP/FRESH/RT/SS | 14000 | 279.1 | 36.8 | 39.3 | 23.6 | 989.1 | 978.2 | 2707.6 | 197.5 | 95.8 | 7072.3 | 1800.4 | 713 | 4471.7 | 2351 | 147.7 | 446.4 |
| | UP/HA/RT/SS | 7609.2 | 216.8 | 8.1 | 13.6 | 13 | 733.3 | 260.3 | 792.6 | 356.4 | 291.6 | 923.9 | 3149.1 | 85.6 | 110.9 | 41.3 | 263.8 | 185.6 |
| | PR/FRESH/RT/SS | 14000 | 130.5 | | | | | | 2241.9 | 105.1 | 140.7 | 3875.1 | 320.2 | 198.1 | 394.9 | 13.1 | 862.4 | 241.5 |
| Rivet | UP/MD | 0.09 | 0.13 | 0.24 | 0.36 | 0.35 | 0.12 | 0.1 | 0.07 | 0.04 | 0.043 | 0.078 | 0.078 | 0.07 | 0.041 | 0.097 | 0.063 | 0.06 |
| | UP/CD | 0.09 | 0.12 | 0.42 | 0.51 | 0.51 | 0.12 | 0.11 | 0.054 | 0.038 | 0.063 | 0.06 | 0.074 | 0.063 | 0.081 | 0.066 | 0.068 | 0.057 |
| | PR/MD | 0.12 | 0.36 | 0.34 | 0.4 | 0.48 | 0.17 | 0.14 | 0.044 | 0.041 | 0.024 | 0.039 | 0.076 | 0.054 | 0.06 | 0.1 | 0.046 | 0.071 |
| | PR/CD | 0.12 | 0.38 | 0.48 | 0.58 | 0.62 | 0.19 | 0.17 | 0.087 | 0.061 | 0.033 | 0.033 | 0.071 | 0.052 | 0.063 | 0.072 | 0.062 | 0.055 |
| Accelerated | UP | 175 | 170 | 172 | 169 | 169 | 162 | 169 | 174 | 180 | 174 | 177 | 169 | 174 | 164 | 178 | 172 | 167 |
| LTR | PR | 175 | 180 | 172 | 167 | 172 | 162 | 162 | 174 | 120 | 174 | 172 | 166 | 171 | 162 | 174 | 171 | 164 |
| | TOTAL (UP AND | 350 | 350 | 344 | 336 | 341 | 324 | 331 | 348 | 300 | 348 | 349 | 335 | 345 | 326 | 352 | 343 | 331 |
| | PR) | | | | | | | | | | | | | | | | | |
| WOM LTR | UP-2000 HR | 157 | 180 | 162 | 157 | 157 | 152 | 157 | 153 | 180 | 180 | 170 | 170 | 180 | 180 | 180 | 166 | 166 |
| | PR-2000 HR | 157 | 138 | 162 | 157 | 150 | 138 | 162 | 180 | 180 | 180 | 173 | 173 | 180 | 173 | 173 | 173 | 173 |
| | TOTAL-2000 HR | 314 | 318 | 324 | 314 | 307 | 290 | 319 | 333 | 360 | 360 | 343 | 343 | 360 | 353 | 353 | 339 | 339 |
| WPI | | 4.5 | 4.86 | 4 | 4.3 | 3.2 | 4.7 | 4.5 | 4.9 | 4.9 | 4.7 | 5.2 | 4.2 | 6.1 | 6 | 5.9 | 5.2 | 5.5 |
| 24 hour Peel | FRESH 24 HR 80″/ | 3.39 | 5.64 | 2.8 | 3.88 | 3.4 | 3.11 | 3.1 | 4.2 | 2.8 | 3.1 | 2.8 | 3.6 | 3 | 2.8 | 2.8 | 3.6 | 4.1 |
| | min PA | | | | | | | | | | | | | | | | | |
| Heat Aged Peel | AGED 80″/min PA | 5.28 | 6.54 | 3.2 | 4.31 | 3.8 | 5.03 | 4.5 | 5.8 | 4.2 | 4.2 | 4.7 | 5.1 | 4.5 | 4.6 | 4.3 | 4.9 | 5.6 |
| Tent | 24 hour | 14 | | 30 | 30 | 30 | 27.67 | 30 | 13.67 | | 30 | 21 | | 30 | | 30 | 19 | |
| Chalky Panel | | POOR | | | | | | | | | | | | | | | | |

| | | Polymer Examples | | | | | |
|---|---|---|---|---|---|---|---|
| EXAMPLE | | 32A | 33A | 34A | 35A | 36A | 37A |
| | FoxT_{g} (° C.) | −23 | −26 | −40 | −38 | −38 | −31 |
| | FSP (cal/cm³)^{0 5} | 10.59 | 10.1 | 9.85 | 10.06 | 9.96 | 10.26 |
| | Face | PVC | PVC | PVC | PVC | PVC | PVC |
| | Liner | EZRS | EZRS | EZRS | EZRS | EZRS | EZRS |
| | | (structured) | (structured) | (structured) | (structured) | (structured) | (structured) |
| Peel | 2M/UP/FRESH/PA | 1.8 | 1.1 | 0.9 | 1.3 | 1.2 | 2.3 |
| | 15M/UP/FRESH/PA | 2.3 | 1.2 | 1.1 | 1.3 | 1.2 | 2.3 |
| | 24H/UP/FRESH/PA | 2.4 | 1.6 | 1.3 | 1.4 | 1.3 | 2.8 |
| | 1WK/UP/FRESH/PA | 2.9 | 1.8 | 1.4 | 1.8 | 1.8 | 2.9 |
| | 2M/PR/FRESH/PA | 1.7 | 0.4 | 0.3 | 0.6 | 0.7 | 1.3 |
| | 15M/PR/FRESH/PA | 1.8 | 0.5 | 0.4 | 0.6 | 0.7 | 1.3 |
| | 24H/PR/FRESH/PA | 2.2 | 0.8 | 0.5 | 0.8 | 0.9 | 2 |
| | 1WK/PR/FRESH/PA | 2.5 | 1.1 | 0.7 | 1.2 | 1.2 | 2.4 |
| | 2WK60C/UP/FRESH/PA | | | | | | |
| | 2WK60C/PR/FRESH/PA | | | | | | |
| | 2M/UP/HA/PA | | | | | | |
| | 15M/UP/HA/PA | | 1.1 | 0.9 | 0.8 | 0.8 | 2.4 |
| | 24H/UP/HA/PA | | | | | | |
| | 1WK/UP/HA/PA | | | | | | |
| Tack | UP/FRESH/RT/PA | 2.6 | 1.6 | 1.2 | 1.8 | 1.7 | 2.4 |
| | UP/HA/RT/PA | | | | | | |
| | UP/FRESH/60F/PA | 1.6 | 1.8 | 1.6 | 1.8 | 1.8 | 2.9 |
| | UP/FRESH/45F/PA | 0.9 | 1 | 2.3 | 1.6 | 3.2 | 2.3 |
| | PR/FRESH/RT/PA | 1.8 | 0.9 | 0.6 | 1.3 | 1.3 | 2.1 |
| | PR/FRESH/60F/PA | 2.3 | 1.2 | 0.7 | 1.2 | 1.5 | 2.4 |
| | PR/FRESH/45F/PA | 1 | 1.6 | 1.1 | 2.1 | 1.9 | 2.8 |
| Shear | UP/FRESH/RT/SS | 4102 | 14.9 | 2 | 10.9 | 7.3 | 125.3 |
| | UP/HA/RT/SS | | | | | | |
| | PR/FRESH/RT/SS | 270.5 | 7 | 1 | 4.2 | 4.9 | 23.8 |
| Rivet | UP/MD | 0.1 | 0.1 | 0.2 | 0.1 | 0.1 | |
| | UP/CD | 0.1 | 0.1 | 0.2 | 0.3 | 0.2 | |
| | PR/MD | 0.1 | 0 | 0.1 | 0.1 | 0.1 | |
| | PR/CD | 0.1 | 0.2 | 0 | 0.1 | 0.3 | |
| Accelerated LTR | UP | 175 | 175 | 180 | 180 | 180 | 162 |
| | PR | 177 | 180 | 180 | 180 | 180 | 144 |
| | TOTAL (UP AND PR) | 352 | 355 | 360 | 360 | 360 | 306 |
| WOM LTR | UP—2000 HR | 157 | 169 | 174 | 174 | 174 | 159 |
| | PR—2000 HR | 147 | 174 | 174 | 174 | 174 | 64 |
| | TOTAL—2000 HR | 304 | 343 | 348 | 348 | 348 | 223 |
| WPI | | | | | | | |
| 24 hour Peel | FRESH 24 HR 80″/min PA | | | | | | |
| Heat Aged Peel | AGED 80″/min PA | | | | | | |
| Tent | 24 hour | | | | | | |
| Chalky Panel | | POOR | GOOD | GOOD | OK | OK | OK |

When ranges are used herein for physical properties, such as molecular weight, or chemical properties, such as chemical formulae, all combinations, and subcombinations of ranges specific embodiments therein are intended to be included.

The disclosures of each patent, patent application, and publication cited or described in this document are hereby incorporated herein by reference, in their entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed is:

1. A film construction, comprising:
a backing film have a first side and a second side; and
a pressure sensitive adhesive provided on at least a portion of said first side of said backing film;
wherein said pressure sensitive adhesive comprises at least one polymer and an optional crosslinker;
wherein said polymer comprises polymerized residues of:
about 40% by weight to about 90% by weight, based on the total weight of the polymer, of at least one monomer A having a glass transition temperature of no more than about 0° C., when polymerized as a homopolymer;
about 0% by weight to about 10% by weight, based on the total weight of the polymer, of at least one monomer B having a glass transition temperature of greater than about 0° C., when polymerized as a homopolymer, and a Fedors Solubility Parameter of no more than about 10.5, when calculated for a homopolymer of said monomer B;
about 0.5% by weight to about 45% by weight, based on the total weight of the polymer, of at least one monomer C having a glass transition temperature of greater than about 0° C., and a Fedors Solubility Parameter of greater than about 10.5, when calculated for a homopolymer of said monomer C;
wherein said monomer C is a monomer selected from the group consisting of alkyl (meth)acrylate, vinyl monomer, and combinations thereof;
wherein said monomer C optionally comprises at least one functional group capable of crosslinking;
about 0% by weight to about 30% by weight, based on the total weight of the polymer, of at least one monomer D having a glass transition temperature of greater than about 0° C.;
wherein said monomer D is a nitrogen-containing monomer; and
wherein said polymer has a Fedors Solubility Parameter of less than about 10.3.

2. The film construction of claim 1,
wherein said film construction removes cleanly from a smooth surface.

3. The film construction of claim 1 or claim 2,
wherein said film construction removes cleanly from an aged, rough, or chalky surface or a combination thereof.

4. The film construction of any one of claims 1-3,
wherein said film construction removes cleanly from an aged, rough, or chalky surface or a combination thereof after at least 5 years of installation on said surface, based on accelerated long term removability (LTR) protocol.

5. The film construction of any one of claims 1-4,
wherein said polymer has a glass transition temperature of about −20° C. to about −50° C.

6. The film construction of any one of claims 1-5,
wherein said polymer has a Fedors Solubility Parameter of about 9.8 to about 10.3.

7. The film construction of any one of claims 1-6,
wherein said monomer A is a monomer selected from the group consisting of butyl acrylate, 2-ethylhexyl acrylate, isooctyl acrylate, 4-hydroxy butyl acrylate, ethyl acrylate, n-hexyl acrylate, 2-propyl heptyl acrylate, hydroxyl propyl acrylate, and combinations thereof.

8. The film construction of any one of claims 1-7,
wherein said monomer B is a monomer selected from the group consisting of methyl methacrylate, ethyl methacrylate, n-butyl methacrylate, iso-butyl methacrylate, tert-butyl (meth)acrylate, cyclohexyl methacrylate, isobornyl (meth)acrylate, propyl methacrylate, α-methyl styrene, and combinations thereof.

9. The film construction of any one of claims 1-8,
wherein said monomer C is a monomer selected from C₁-C₄ alkyl (meth)acrylate, (meth)acrylic acid, vinyl acetate, styrene, (meth)acrylic anhydride, maleic anhydride, and combinations thereof.

10. The film construction of claim 9,
wherein said monomer C is a monomer selected from methyl acrylate, glycidyl (meth)acrylate, (meth)acrylic acid, maleic anhydride, and combinations thereof.

11. The film construction of any one of claims 1-10,
wherein said functional group capable of crosslinking is a functional group selected from the group consisting of hydroxyl, carboxyl, organic diacid anhydride, silyl, carbonyl, carbonate ester, isocyanato, epoxy, vinyl, amino, amide, imide, anhydride, mercapto, acid, acetoacetyl groups, and combinations thereof.

12. The film construction of any one of claims 1-11,
wherein said monomer D is a monomer selected from the group consisting of N,N-dimethyl (meth)acrylamide, N,N-diethyl (meth)acrylamide, N,N-dipropyl acrylamide, N,N-dimethyl amino ethyl (meth) acrylamide, N,N-dimethyl amino propyl (meth)acrylamide, N,N-diethyl amino ethyl (meth)acrylamide, N,N-diethyl amino propyl (meth)acrylamide, n-(C₁-C₈)alkyl acrylamide, and combinations thereof.

13. The film construction of any one of claims 1-12,
wherein said polymer is a copolymer comprising 2-ethyl hexyl acrylate, methyl acrylate, (meth)acrylic acid, optionally methyl methacrylate, and optionally N,N-dimethyl acrylamide.

14. The film construction of any one of claims 1-13,
wherein said polymer comprises about 55% by weight to about 70% by weight, based on the total weight of the polymer, of monomer A.

15. The film construction of any one of claims 1-14,
wherein said polymer comprises about 2% by weight to about 8% by weight, based on the total weight of the polymer, of monomer B.

16. The film construction of any one of claims 1-15,
wherein said polymer comprises about 25% by weight to about 45% by weight, based on the total weight of the polymer, of monomer C.

17. The film construction of any one of claims 1-16,
wherein said polymer comprises about 1% by weight to about 15% by weight, based on the total weight of the polymer, of monomer D.

18. A film construction, comprising:
a backing film have a first side and a second side; and
a pressure sensitive adhesive provided on at least a portion of said first side of said backing film;
wherein said pressure sensitive adhesive comprises at least one polymer and an optional crosslinker;
wherein said polymer has a glass transition temperature of about −20° C. to about −50° C.; and
wherein said polymer has a Fedors Solubility Parameter of less than about 10.3;
wherein said film construction removes cleanly from an aged, rough, or chalky surface, or a combination thereof after at least 5 years of installation on said surface, based on accelerated long term removability (LTR) protocol; and
wherein said film construction passes a 2-minute Cold Peel Test with at least 0.75 lbs. of peel.

19. A method of protecting a surface, comprising:
applying said film construction of any one of claims 1-17 to said surface.

20. The method of claim 19,
wherein said surface is a smooth surface.

21. The method of claim 19,
wherein said surface is an aged, rough, or chalky surface, or a combination thereof.

22. The method of any one of claims 19-21,
wherein said film construction removes cleanly after at least 5 years of installation on said surface, based on accelerated aging testing in accordance with ISO 4892-2 (2013) protocol;
whether or not said surface was originally smooth.

23. The method of any one of claims 19-22,
wherein said film construction removes after at least 10 years of installation on said surface, based on accelerated long term removability (LTR) protocol;
whether or not said surface was originally smooth.

24. The method of any one of claims 19-23,
wherein said surface comprises at least one material selected from the group consisting of unpainted metal, painted metal, glass, and fiberglass.

25. A method of protecting a surface, comprising:
applying said film construction of claim 18 to said surface.

26. The method of claim 25,
wherein said surface is a smooth surface.

27. The method of claim 25,
wherein said surface is an aged, rough, or chalky surface, or a combination thereof.

28. The method of any one of claims 25-27,
wherein said film construction removes cleanly after at least 5 years of installation on said surface, based on accelerated long term removability (LTR) protocol;
whether or not said surface was originally smooth.

29. The method of any one of claims 25-28,
wherein said film construction removes after at least 10 years of installation on said surface, based on accelerated long term removability (LTR) protocol;
whether or not said surface was originally smooth.

30. The method of any one of claims 25-29,
wherein said surface comprises at least one material selected from the group consisting of unpainted metal, painted metal, glass, and fiberglass.
